(19) United States
(12) Patent Application Publication
(10) Pub. No.: US 2017/0256044 A1
(43) Pub. Date: Sep. 7, 2017

(54) DEVICE SELECTING APPARATUS, METHOD AND PROGRAM

(71) Applicant: Kabushiki Kaisha Toshiba, Tokyo (JP)

(72) Inventors: Masayuki MARUYAMA, Koto-ku Tokyo (JP); Osamu YAMAGUCHI, Aoba-ku Yokohama Kanagawa (JP); Tomoyuki SHIBATA, Miyamae-ku Kawasaki Kanagawa (JP)

(21) Appl. No.: 15/260,182

(22) Filed: Sep. 8, 2016

(30) Foreign Application Priority Data
Mar. 1, 2016 (JP) 2016-039114

(51) Int. Cl. G06T 7/00; G06K 9/00; G06K 9/52; G06K 9/46; G06K 9/62

(52) U.S. Cl. CPC G06T 7/0004; G06K 9/4671; G06T 7/0042; G06K 9/6267; G06K 9/52; G06K 9/00335; G06K 9/6215; G06T 2207/30242; G06T 2215/16; G06K 2009/4666

(57) ABSTRACT

Disclosed is a device selecting apparatus including: processing circuitry. The processing circuitry is configured to: acquire an image including a plurality of devices provided in a real world; set one device in operation, set an image setting region corresponding to the one device on the image, and calculate an image congestion degree of persons existing in the image setting region; calculate a real setting region on the real world corresponding to the image setting region from a positional relationship between the image and the real world, and calculate a real congestion degree in the real setting region from the image congestion degree; and, when the real congestion degree meets a predetermined first criterion, select a stopped device other than the set device in operation based on a predetermined first selection rule, and output operation information of the selected stopped device.

### CROSS-REFERENCE TO RELATED APPLICATIONS

This application is based upon and claims the benefit of priority from the prior Japanese Patent Application No. 2016-39114, filed on Mar. 1, 2016; the entire contents of which are incorporated herein by reference.

### FIELD

Embodiments described herein relate to a device selecting apparatus, a method and a program.

### BACKGROUND

There has been conventionally proposed a technique for eliminating a congestion by calculating the number of persons by a camera and guiding persons based on a result of the calculation.

However, in such a conventional technique, since congestion alleviation is made based on the total number of persons in a capturing range, rather than based on the uneven local distribution of the number of persons in the capturing range, it is impossible to determine which to select and operate out of devices in order to alleviate the congestion.

In view of the above circumstances, an object of an embodiment of the present invention is to provide a device selecting apparatus, a method, and a program for selecting a device, which is capable of alleviating a congestion based on uneven distribution of the number of persons in an acquired image.

### BRIEF DESCRIPTION OF THE DRAWINGS

FIG. 1 is a block diagram illustrating a device selecting apparatus according to a first embodiment of the present invention;

FIG. 2 is a flowchart illustrating a process of the device selecting apparatus;

FIG. 3 is a view illustrating an image obtained by capturing three cash registers with one camera;

FIG. 4 is a view illustrating that an image setting region is set on an image;

FIG. 5 is a view illustrating that an image setting region is set on an image with increased congestion;

FIG. 6 is a view illustrating a boundary line provided to prevent image setting regions on an image from being connected;

FIG. 7 is a plan view of the real world in a case where a procession of shoppers is formed in front of two cash registers;

FIG. 8A is a view of an image in a case where a procession of shoppers is curved in front of one cash register and FIG. 8B is a plan view of the real world thereof;

FIG. 9 is a view of an image in a case where shoppers are congested in front of one cash register;

FIG. 10 is a view of an image in a case where congestion of shoppers in front of a cash register is eliminated;

FIG. 11 is a view of an image in a state where partition poles are recognized through an image; and

FIG. 12 is a block diagram illustrating an example of the hardware configuration of a device selecting apparatus.

### DETAILED DESCRIPTION

According to one embodiment, there is provided a device selecting apparatus including: processing circuitry configured to: acquire an image including a plurality of devices provided in a real world; set one device in operation, set an image setting region corresponding to the one device on the image, and calculate an image congestion degree of persons existing in the image setting region; calculate a real setting region on the real world corresponding to the image setting region from a positional relationship between the image and the real world, and calculate a real congestion degree in the real setting region from the image congestion degree; and, when the real congestion degree meets a predetermined first criterion, select a stopped device other than the set device in operation based on a predetermined first selection rule, and output operation information of the selected stopped device.

Hereinafter, a device selecting apparatus 10 of embodiments of the present invention will be described with reference to the drawings.

A device selecting apparatus 10 is, for example, a dedicated or general-purpose computer. The device selecting apparatus 10 includes a bus 104 connecting a camera 100, a processing circuitry 101, a memory circuit 102 and a communication device 103.

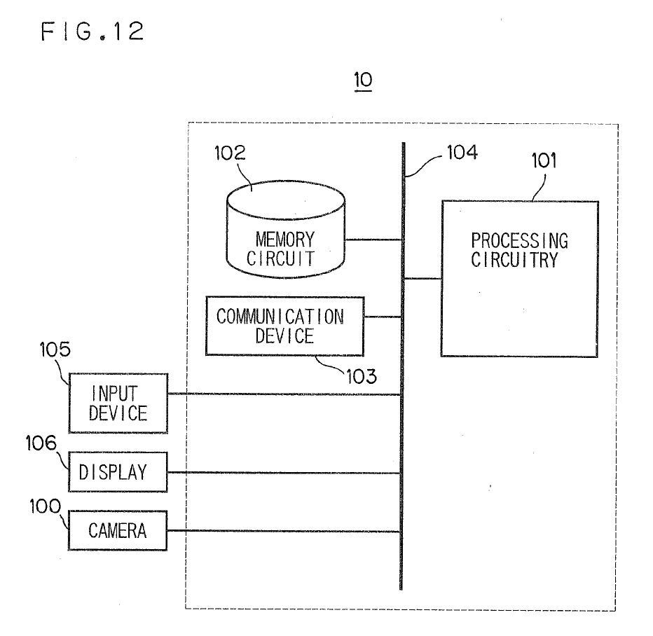

The processing circuitry 101 includes an image acquisition unit 11, a first calculation unit 12, a second calculation unit 13 and a selection unit 14, which will be described later. Although functions related to the present embodiment are mainly illustrated in the example of FIG. 12, the respective units of the processing circuitry 101 are not limited thereto. The function of each of the units will be described in detail later.

The function of each unit performed in the device selecting apparatus 10 is stored in the memory circuit 102 in the form of a computer-executable program. The processing circuitry 101 is a processor for reading and executing a program from the memory circuit 102 to implement a function corresponding to the program. The processing circuitry 101 in a state of reading each program has the function of each unit illustrated in the processing circuitry 101 of FIG. 12. FIG. 12 illustrates that the functions performed in the image acquisition unit 11, the first calculation unit 12, the second calculation unit 13 and the selection unit 14 are implemented in a single processing circuitry 101. Alternatively, these functions may be implemented by constructing the processing circuitry 101 in combination of a plurality of independent processors and causing the processors to execute their respective programs. Each processing function may be configured as a program, and a single processing circuitry 101 may execute each program. Alternatively, a specified function may be installed in a dedicated independent program executing circuit.

The image acquisition unit 11, the first calculation unit 12, the second calculation unit 13, and the selection unit 14 included in the processing circuitry 101 are examples of an image acquisition unit, a first calculation unit, a second calculation unit, and a selection unit, respectively.

The term “processor” used in the above description refers to one of, e.g., a central processing unit (CPU), a graphical processing unit (GPU), an application specific integrated circuit (ASIC) and a programmable logic device (e.g., a simple programmable logic device (SPLD), a complex programmable logic device (CPLD) or a field programmable gate array (FPGA)). The processor implements a function by reading and executing a program stored in the memory circuit 102. Instead of being stored in the memory circuit 102, the program may be directly embedded in a circuit of the processor. In this case, the processor implements the function by reading and executing the program embedded in the circuit of the processor.

The memory circuit 102 stores data (e.g., an image) and the like associated with the functions of the respective units performed by the processing circuitry 101, as necessary. The memory circuit 102 stores programs of the functions of the respective units. For example, the memory circuit 102 is a semiconductor memory device such as a random access memory (RAM) or a flash memory, a hard disk, an optical disc, or the like. A process performed by the memory circuit 102 in the processing circuitry 101 may be replaced with an external storage device of the device selecting apparatus 10. The memory circuit 102 may be a storage medium which downloads and stores or temporarily stores a program transmitted via a local area network (LAN), the Internet or the like. The storage medium is not limited to a single form. The storage medium of the embodiment may include even a plurality of media from which the process in the above-described embodiment is executed. The storage medium may have any configuration.

The communication device 103 is an interface for exchanging information with an external device connected by a wire or wirelessly. For example, the communication device 103 may be used for communication conducted when the selection unit 14 outputs operation information to a device or a controller of a manager as described below.

An input device 105 receives a variety of instructions or input information related to the device selecting apparatus 10 from an operator. The input device 105 is, e.g., a pointing device such as a mouse or a trackball, or an input device such as a keyboard.

A display 106 displays a variety of information about the device selecting apparatus 10. The display 106 is a display device, e.g., a liquid crystal display device. The display 106 displays, e.g., an image of obstacle mapping.

In the present embodiment, the input device 105 and the display 106 are connected to the device selecting apparatus 10 by a wire or wirelessly. The input device 105 and the display 106 may be connected to the device selecting apparatus 10 via a network.

In one embodiment, a computer or an embedded system is provided to execute each process in the embodiment based on a program stored in a storage medium, and may be a single device such as a personal computer or a microcomputer, or alternatively may be any configuration such as a system including a plurality of devices connected to a network.

The term “computer” in the embodiment is not limited to a personal computer but covers an arithmetic processing device included in an information processing apparatus, a microcomputer, etc and refers generally to devices and apparatuses capable of realizing the functions in the embodiment by a program.

### First Embodiment

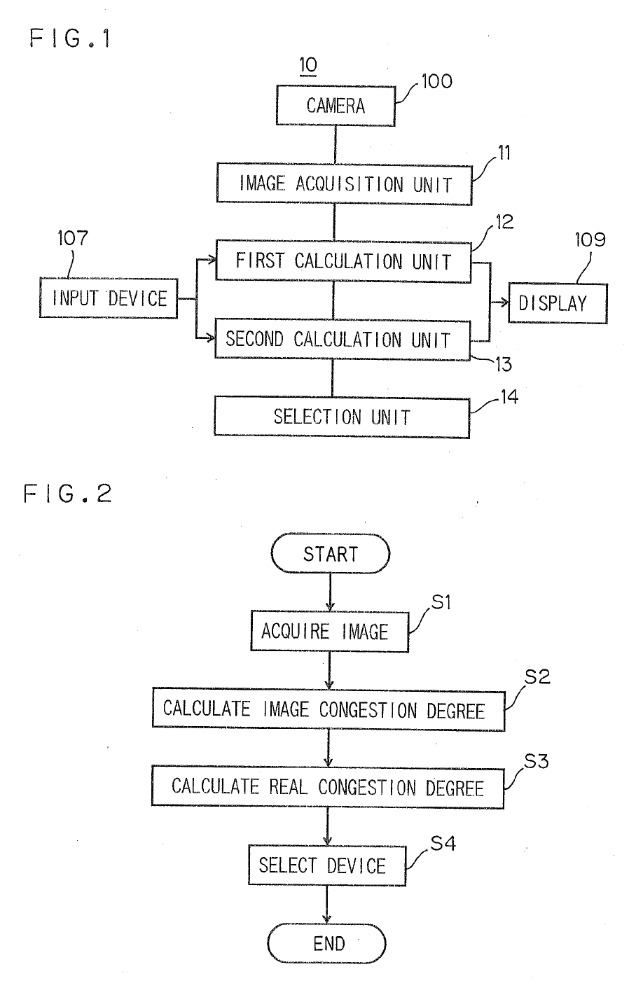

Hereinafter, a device selecting apparatus 10 of a first embodiment of the present invention will be described with reference to FIGS. 1 and 2.

The device selecting apparatus 10 will be described based on a block diagram of FIG. 1. As illustrated in FIG. 1, the device selecting apparatus 10 includes the image acquisition unit 11, the first calculation unit 12, the second calculation unit 13, and the selection unit 14.

The term “device” refers to a device operated in order by a plurality of persons in procession or a device through which a plurality of persons in procession pass. Examples of the device include a cash register in a supermarket, a retail store or the like, a vending machine, a ticket vending machine in a station, a movie theater, a restaurant, an amusement park or the like, an ATM in a bank, a boarding gate in an airport, and an entrance gate in an entrance of a stadium or an amusement park, or the like. In the present embodiment, a plurality of devices is arranged in a line. The device selecting apparatus 10 and the plurality of devices are managed by a manager. The devices are automatically operated based on an operation signal from the device selecting apparatus 10 or are manually operated based on an operation signal by the manager. In addition, the devices are automatically stopped based on a stop signal from the device selecting apparatus 10 or are manually stopped based on a stop signal by the manager.

One camera 100 may be connected to the image acquisition unit 11 and may be installed in a building or the outdoor to capture a range for which a degree of congestion of persons is to be calculated. Further, the plurality of devices are installed so as to be captured in the same image 8. In addition, when the camera 100 is installed, a camera parameter representing a positional relationship between the world coordinate system and an image coordinate system (a positional relationship between an image and the real world) is obtained in calibration. A relationship between the real world positions in the world coordinate system and positions on the image 8 in the image coordinate system is calculated by projecting the real world positions onto the positions on the image 8 based on the camera parameter or conversely projecting the positions on the image 8 onto the real world positions.

In addition, the input device 105, such as a mouse, a pen, or a keyboard, and the display 106 are connected to the first calculation unit 12 and the second calculation unit 13. Hereinafter, the units 11 to 14 will be described based on a flow chart of FIG. 2.

At Step S1, the image acquisition unit 11 acquires an image 8 at time t1 from the camera 100. The term “image 8” refers to a still image or one frame of a video. In addition, subsequent to time t1, the image acquisition unit 11 acquires images 8 at times t2 and t3.

At Step S2, the first calculation unit 12 calculates a degree (s) of image congestion within one or more image setting regions which are set on the acquired image 8 at time t1.

The term “image congestion degree” refers to a statistics based on persons within the image setting region on the image 8. For example, the image congestion degree may be a proportion of an area that persons occupy in a unit region or the number of persons in the unit region. The first calculation unit 12 calculates an image congestion degree by detecting an upper half body or head of a person. In addition, the first calculation unit 12 may calculate the image congestion degree by dividing the image 8 into small regions (e.g., regions of 10×10 pixels), machine-learning a relationship between the number of persons in each small region and a feature (e.g., a texture) in the small region, and obtaining the number of persons in each small region.

The term “image setting region” refers to a region on the image 8 used to calculate an image congestion degree corresponding to a particular device and is set after the camera 100 is installed and the camera parameter is obtained. How to set the image setting region will be described below. A method by the first calculation unit 12 to obtain an image setting region will now be described.

First, a method of setting an initial image setting region at a time (time t1) of starting congestion measurement will be described.

As a first setting method, a manager sets identification information of a particular device and directly sets an image setting region on the image 8 through the input device 105 while watching the display 106. Then, the first calculation unit 12 associates the set identification information of the device (hereinafter referred to as “setting identification information”) with the set image setting region.

As a second setting method, the manager sets identification information of a particular device and designates a region on a drawing of the real world (a road map, a store design drawing, etc.) and the first calculation unit 12 projects a corresponding region on the image 8 onto the designated region on the real world drawing using a camera parameter and sets the projected region on the image 8 as the image setting region. Then, the first calculation 12 associates the set setting identification information of the device and the set image setting region with each other.

As a third setting method, the manager designates a position (one point) on the image 8 or the real world as a reference and the first calculation unit 12 projects the designated point onto the image 8 and sets a predetermined range that is within a certain distance from the projected point as the image setting region. The manager sets identification information of the particular device. Then, the first calculation unit 12 associates the set setting identification information of the device and the set image setting region with each other.

A fourth setting method is applicable to a case where a form of crowds of persons is known based on a real world structure in advance. In this case, the first calculation unit 12 detects a structure within a range captured by the camera 100 through image recognition and sets the image setting region based on a result of the detection. In addition, the manager sets identification information of a particular device. Then, the first calculation unit 12 associates the set setting identification information of the device and the set image setting region with each other. The term “structure” refers to partition poles, guide lines drawn on floor or ground, etc., in order to make arrangement of shelves installed in a room or in outdoor, roads, passages, processions, and the like.

Next, since image setting regions are changed with time according to a state of movement of persons, the first calculation unit 12 connects or separates the image setting regions based on the temporal change.

With regard to connection or separation of image setting regions, a distance between an existing congestion A (a group or one person) at time t0 before time t1 and an additional congestion B between time t0 and time t1 (a group or one person) is obtained. If the obtained distance is equal to or less than a predetermined distance threshold r, a range of congestion A and a range of congestion B are connected. When there are a plurality of existing congestions, the congestion B is connected to the existing congestion having the shortest distance. If the obtained distance is more than the distance threshold s, the range of congestion A and the range of congestion B are separated. The distance between the congestion A and the congestion B on the image 8 will be illustrated as follows.

As a first example, an urban district distance between the center of gravity coordinate of the congestion A and the center of gravity coordinate of the congestion B is assumed as the distance between the congestion A and the congestion B.

As a second example, a Euclidean distance between one point P among pixels included in the range of congestion A and one point Q among pixels included in the range of congestion B is obtained and the smallest one of distances obtained for combinations of all points P and Q is assumed as the distance between the congestion A and the congestion B.

In a case where a plurality of existing congestions exists on the image 8 and a significant distance difference on the image 8 is not obtained, that is, in a case where persons on the image 8 (e.g., the heads when a congestion degree is measured based on a head feature) overlap with each other, even if reasonable connection or separation is made on the image 8, a result thereof may be likely to be improper. In this case, for the connection or separation on the image 8, the regions are forced to be divided at a predetermined boundary as illustrated in FIG. 6.

In the meantime, in a case where it is hard to make separation on the image 8, image setting regions are first projected onto the real space and how many meters the image setting regions are spaced on the real space is calculated to determine whether to make the connection or separation.

Determination on whether to make connection on the image 8 or the real space is made, for example, as follows.

First, it is assumed that the existing congestions A and B exist on the image 8 and new congestion C occurs additionally and that a distance between the congestion A and the congestion B is a and a distance between the congestion A and the congestion C is b. Then, two distance thresholds, i.e., a distance threshold r1 for determination on connection and a distance threshold r2 for giving-up of the determination, are prepared. Here, it is further assumed that r1>r2.

The first calculation unit 12 connects the congestion C to the congestion A when r2<a<b<r1, r2<a<r1<b, a<r2<b<r1, or a<r2<r1<b.

When a<b<r2, the first calculation unit 12 gives up determination on the connection on the image 8 or forcibly divides the image 8 into image setting regions.

When r2<r1<a<b, the first calculation unit 12 connects the congestion C to none of the congestion A and the congestion B.

The first calculation unit 12 may project the image 8 onto the real space without making connection or separation on the image 8. However, since there occurs a positional error due to a person height difference detected in the projection of the image 8 onto the real space, separation on the image 8 provides higher accuracy when significant connectivity on the image 8 can be measured.

At Step S3, the second calculation unit 13 calculate a region on the real world (hereinafter referred to as a “real setting region”) corresponding to the image setting region on the image 8 at time t1, using the camera parameter.

Next, the second calculation unit 13 calculates the density of persons in the real setting region (hereinafter referred to as a “real congestion degree”) at time t1 from the image congestion degree. Since the real congestion degree is the number of persons per unit area, for example, the number of persons per square meter, and the image congestion degree represents the proportion of an area that persons occupy in the unit region or the number of persons in the unit region, the second calculation unit 13 calculates the real congestion degree by transforming the image congestion degree so that a transformation result corresponds to the area of the real setting region.

The transformation from the image congestion degree to the real congestion degree is obtained by Homography transformation from a screen (a plane of the image 8) onto a plane which is at a height h from the floor and in parallel to the floor. A parameter of this Homography transformation is obtained from the camera parameter. A setting value of the height h is varied depending on a portion of a person detected to obtain the real congestion degree. For example, the height h is the stature of a person when a head feature is used for measurement of the real congestion degree, and is the height of the upper end (i.e., stature) of an upper half body rectangle or the height of the lower end (i.e., the height of a solar plexus) of the upper half body rectangle when an upper half body feature is used for measurement of the real congestion degree. According to statistics, since the mean stature of the Japanese is about 170 cm for male and about 158 cm for female, when the head feature is used to measure the real congestion degree, for example, h may be set to 164 cm. In addition, similarly, for the lower end of the upper half body rectangle, a mean value of heights of the solar plexus of the body may be used to set h to 117 cm.

Next, the second calculation unit 13 associates the set setting identification information of the device, which is associated with the image setting region at time t1, with the calculated real setting region as it is.

At Step S4, when the real congestion degree of the real setting region at time t1 meets a predetermined first criterion, the selection unit 14 calls the setting identification information of the device associated with the real setting region. Then, the selection unit 14 may select one or more identification information (hereinafter referred to as “selection identification information)” of devices other than the device having the setting identification information based on a predetermined first selection rule and operates the selected device(s), thereby alleviating or eliminating the congestion of persons at time t1.

When the device having the selection identification information is operated, the selection unit 14 outputs operation information (a voice signal or a text signal representing the selection identification information) to the device directly or outputs the operation information to a controller of the manager.

A first criterion is a criterion representing a state where congestion is severe. For example, a real congestion degree is equal to or more than a first congestion threshold (3 persons/m²).

The first selection rule includes, e.g., the following rules which are stored in the selection unit 14. In addition, it is premised on that n devices are arranged in a line, one of the n devices has setting identification information, selection is made out of only stopped devices.

A first rule is that one or more devices that are stopped and are adjacent to a device having setting identification information on one side or both sides thereof are selected as stopped devices.

A second rule is that, when a device having setting identification information is located in one end of a line, one device that is stopped and is located in the other end of the line is selected.

A third rule is that one or more devices that are stopped and in a line are randomly selected.

A fourth rule is that one or more devices which are stopped and are second devices from a device having setting identification information on one side or both sides thereof are selected.

Although the device selecting apparatus 10 only processes the image 8 at time t1 in the above description, the device selecting apparatus 10 may continue subsequently to process an image 8 at time t2 and an image 8 at time t3 and select a device to be operated at each time. A timing of this process may be every minute, every ten minutes, every 30 minutes or every hour.

According to the present embodiment, it is possible to alleviate or eliminate congestion in real time by specifying a congested real setting region on the real world and outputting operation information every time so as to properly operate a device eliminating this congestion.

### Second Embodiment

Hereinafter, a device selecting apparatus 10 of a second embodiment of the present invention will be described with reference to FIG. 1 and FIGS. 3 to 10. In the present embodiment, the device selecting apparatus 10 includes a camera 100, an image acquisition unit 11, a first calculation unit 12, a second calculation unit 13, a selection unit 14, an input device 105 and a display 106, as illustrated in FIG. 1.

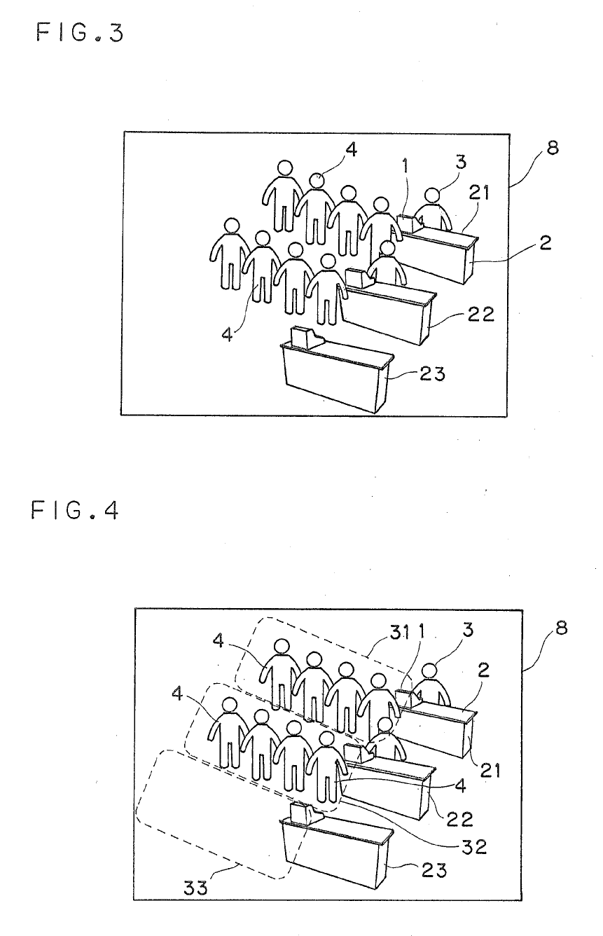

In the present embodiment, a case where the device selecting apparatus 10 is applied to operation and stop of three cash registers 21, 22 and 23 arranged in a line in a retail store such as a supermarket or a convenience store will be described. As illustrated in FIG. 3, a plurality of shoppers 4 forms a line of procession and waits for accounting treatment in front of each cash register. In this application example, the term “device” refers to a cash register with which an employee 3 performs an accounting task, or a self-cash register with which the shoppers 4 perform an accounting task by themselves. The term “register” refers to a register 1 put on a register table 2 with which the employee 3 performs accounting treatment for the shoppers 4. This register is a kind of gate since the shoppers 4 may pass through the cash register 21 or the like when the accounting treatment is completed. A self-register is a register with which the shoppers 4 perform the accounting treatment by themselves instead of the employee 3, and is also a kind of gate since the shoppers 4 may pass through the self-register when the accounting treatment is completed. In addition, as illustrated in FIG. 3, one camera 100 captures the three cash registers 21, 22 and 23 and a range in which the shoppers 4 forma procession. Then, the image acquisition unit 11 acquires an image 8 from the camera 100. It is here assumed that identification information of the cash registers 21, 22 and 23 are “R21,” “R22” and “R23,” respectively.

The first calculation unit 12 calculates an image congestion degree of the shoppers 4 in an image setting region which is set on the acquired image 8 at time t1.

A method of setting the image setting region in order to calculate the image congestion degree of the shoppers 4 is set by a manager through the input device 105 while watching the image 8 displayed on the display 106. In addition, the manager sets identification information of a particular device in the image setting region.

For example, as illustrated in FIG. 4, the manager sets a region of a procession of shoppers 4 in front of the cash register 21 as an image setting region 31 whose setting identification information is set with “R21,” sets a region of a procession of shoppers 4 in front of the cash register 22 as an image setting region 32 whose setting identification information is set with “R22,” and sets a region of a procession of shoppers 4 in front of the cash register 23 as an image setting region 33 whose setting identification information is set with “R23,” on the image 8.

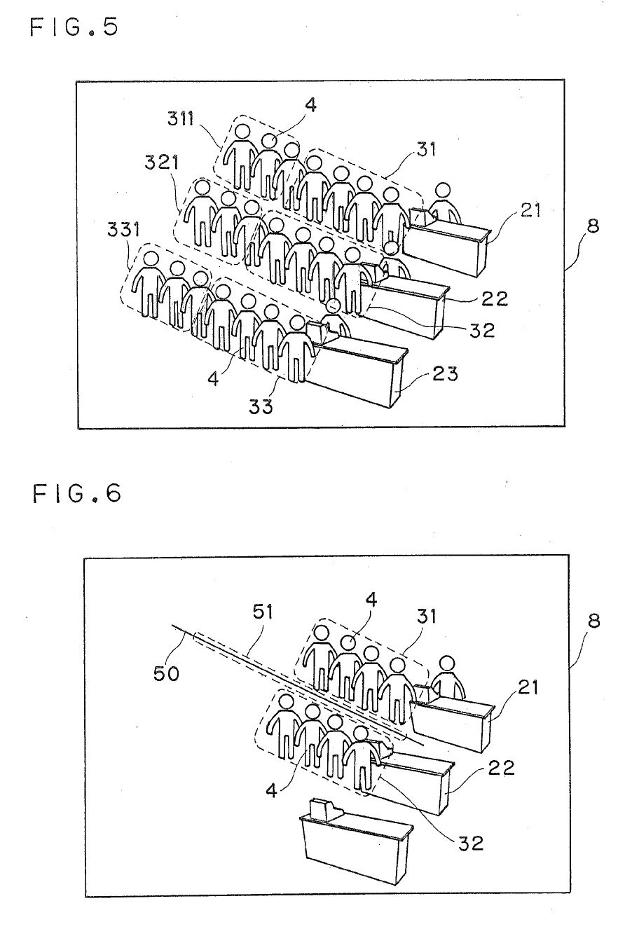

When an image congestion degree of each of the image setting regions 31, 32 and 33 is equal to or more than a predetermined first threshold under the premise that the following first or second condition is met, the first calculation unit 12 extends an image setting region by connecting regions 311, 321 and 331 to the image setting regions 31, 32 and 33, respectively, as illustrated in FIG. 5.

The first condition is when the image congestion degree of each of the adjacent image setting regions 31, 32 and 33 is equal to or more than a predetermined second threshold.

The second condition is when each of a rate of change in image congestion degree of the image setting region 31 and the image setting region 311, a rate of change in image congestion degree of the image setting region 32 and the image setting region 321 and a rate of change in image congestion degree of the image setting region 33 and the image setting region 331 is equal to or less than a predetermined third threshold.

At this time, when the image setting region 31 and the image setting region 32 are not to be connected, the manager sets a boundary line 50 or a boundary region 51 between the image setting region 31 and the image setting region 32 in advance as illustrated in FIG. 6, and the first calculation unit 12 performs a process such that the image setting regions are not connected over the boundary line 50 or the boundary region 51.

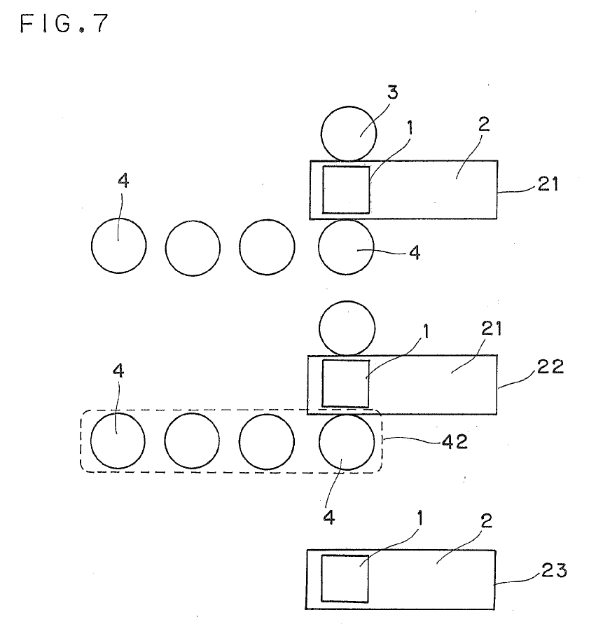

The second calculation unit 13 uses a camera parameter to calculate a real setting region by projecting an image setting region on the image 8 at time t1 onto the real world. The second calculation unit 13 sets real setting regions on the real world corresponding to the image setting regions 31, 32 and 33 illustrated in FIG. 4 as real setting regions 41, 42 and 43 as illustrated in FIG. 7, respectively. Next, the second calculation unit 13 calculates a real congestion degree in the real setting region from the image congestion degree. Next, the second calculation unit 13 associates the setting identification information, which is associated with the image setting region, with the calculated real setting region as it is.

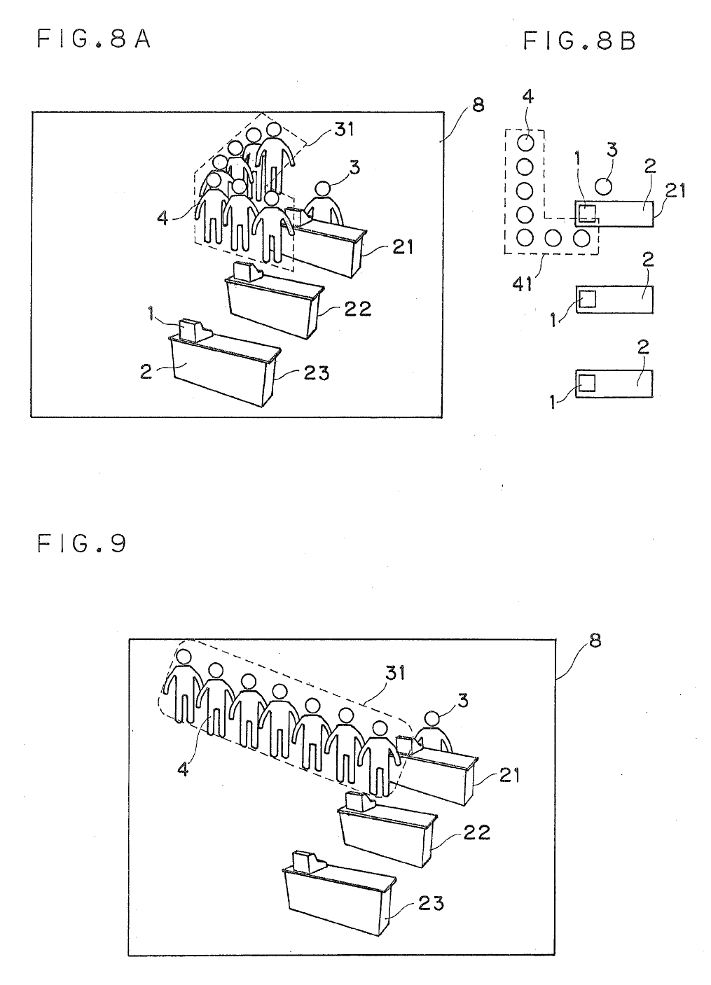

In a case where the procession of shoppers 4 in the image setting region 31 is not linear but curved in an intermediate position thereof as illustrated in FIG. 8A, the curved region is set as the real setting region 41 as illustrated in FIG. 8B.

The selection unit 14 selects an operating cash register based on determination on whether or not a real congestion degree in a real setting region of each cash register at time t1 meets a predetermined criterion.

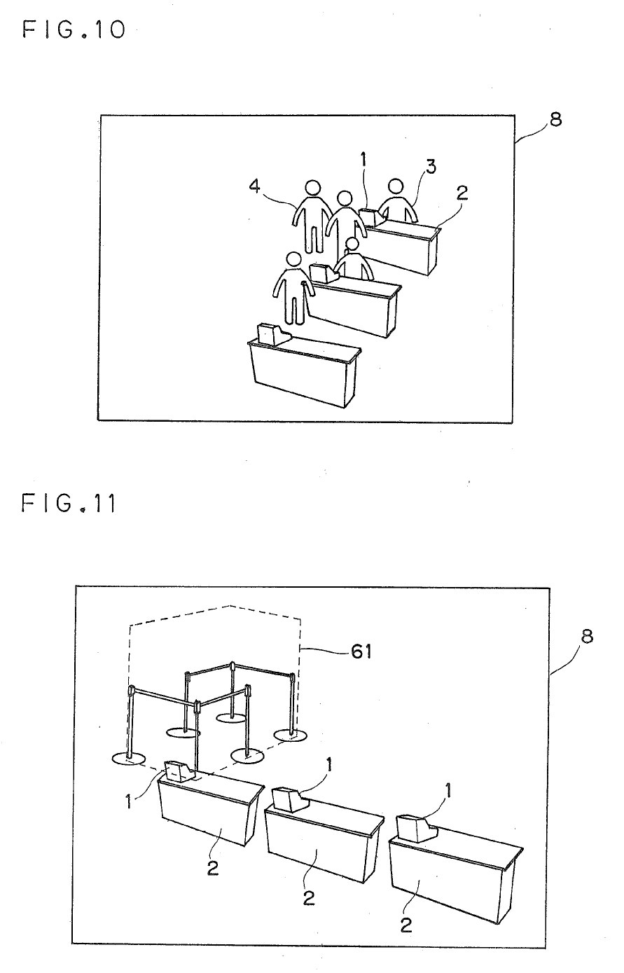

As illustrated in FIG. 9, it is assumed that one cash register 21 is being operated and the real congestion degree of the real setting region 41 of the cash register 21 is high and meets the predetermined first criterion (e.g., a real congestion degree of 3 persons/m² or more).

Since the cash register 21 is already in operation, the selection unit 14 selects selection identification information based on a first selection rule. For example, using the first rule in the first embodiment as the first selection rule, the selection unit 14 selects one cash register 22 adjacent to a device having the setting identification information. The selection unit 14 outputs operation information including selection identification information “R02” of the cash register 22 to the manager such that the selection identification information R02 is operated.

Thereafter, the device selecting apparatus 10 repeats the above-described process every time t in the same way.

According to the present embodiment, it is possible to specify a congested cash register and operate a stopped cash register in real time in order to eliminate this congestion.

In the above description, the selection unit 14 operates a cash register only when congestion is severe. Furthermore, the selection unit 14 may stop a cash register when congestion is alleviated or eliminated. In this case, in addition to the first selection rule, a second selection rule for selecting a cash register to be stopped is stored in the selection unit 14. The second selection rule is a rule that when a plurality of cash registers has low real congestion degrees, one cash register having the lowest real congestion degree is selected and stopped. It is noted that a cash register is stopped premised on that a cash register having the lowest real congestion degree is selected from cash registers in operation.

As illustrated in FIG. 10, it is assumed that two cash registers 21 and 22 are being operated, and the real congestion degrees of the real setting regions 41 and 42 of the cash registers 21 and 22 are low and satisfy a predetermined second criterion (e.g., a real congestion degree of 0.5 person/m² or less). The second criterion is a criterion representing a state where congestion is alleviated or eliminated. For example, the second criterion is a real congestion degree which is equal to or less than a second congestion threshold (1 person/m²). The selection unit 14 selects to stop the cash register 22 based on the second selection rule. Specifically, the selection unit 14 selects a cash register 22 having a lower image congestion degree and a low operation rate based on the second selection rule and outputs stop information including the selection identification information R02 to the manager to allow the manager to stop the cash register 22.

### Third Embodiment

A device selecting apparatus 10 of a third embodiment of the present invention will be described with reference to FIG. 11.

In the present embodiment, as illustrated in FIG. 11, it is assumed that, when a plurality of shoppers 4 forms a procession in a single-line queue (one-line sorting) in a plurality of cash registers or self-cash registers, partition poles for forming the procession are installed near the plurality of cash registers. In this case, the image acquisition unit 11 of the device selecting apparatus 10 detects the partition poles through image recognition and the first calculation unit 12 sets the image-recognized region as an image setting region 61.

### Fourth Embodiment

A device selecting apparatus 10 of a fourth embodiment of the present invention will be described below.

In the second embodiment, a cash register is employed as a device. Alternatively, the device may be a ticket vending machine in a station, a movie theater, a restaurant or the like. In this case, in the same way as the cash register, the device selecting apparatus 10 calculates a real congestion degree of a procession of spectators lined up in front of the ticket vending machine in operation, and outputs operation information to operate another ticket vending machine when the calculated real congestion degree is high.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A device selecting apparatus comprising:
processing circuitry; and
a memory, wherein
the processing circuitry configured to:
acquire an image including a plurality of devices provided in a real world;
set one device in operation, set an image setting region corresponding to the one device on the image, and calculate an image congestion degree of persons existing in the image setting region;
calculate a real setting region on the real world corresponding to the image setting region from a positional relationship between the image and the real world, and calculate a real congestion degree in the real setting region from the image congestion degree; and
when the real congestion degree satisfies a predetermined first criterion, select a stopped device other than the set device in operation based on a predetermined first selection rule, and output operation information of the selected stopped device.

2. The apparatus according to claim 1, wherein the processing circuitry is further configured to:
when the real congestion degree satisfies a predetermined second criterion, select a device in operation other than the set device in operation based on a predetermined second selection rule, and output stop information of the selected device in operation.

3. The apparatus according to claim 1, wherein the processing circuitry is further configured to:
when a distance between congestion included in a image setting region having been set in past and newly added congestion is less than a distance threshold, connect a range of the newly added congestion to the image setting region having been set in past and set the connected congestion range as a new image setting region.

4. The apparatus according to claim 1, wherein the image includes a state where the plurality of devices is arranged in a line, and
wherein the image setting region includes a region where a procession of persons exists.

5. The apparatus according to claim 4, wherein the first rule is a rule of selecting a stopped device adjacent to the set device in operation.

6. The apparatus according to claim 4, wherein the processing circuitry is further configured to:
detect, through image recognition, a fixture aligning or guiding the procession of persons in the image and set the detected fixture in the image setting region.

7. The apparatus according to claim 1, wherein the processing circuitry is further configured to:
when the image congestion degree of the image setting region is higher than a predetermined first threshold, extend the image setting region by connecting a different region to the image setting region.

8. The apparatus according to claim 7, wherein the processing circuitry is further configured to:
when (1) the image congestion degree is higher than the first threshold and (2) a difference between the image congestion degree of the image setting region and an image congestion degree of another image setting region adjacent to the image setting region is lower than a predetermined second threshold, connect the adjacent image setting region to the image setting region.

9. The apparatus according to claim 7, wherein the processing circuitry is further configured to:
when the image congestion degree is higher than the first threshold, not connect another image setting region divided at a set boundary.

10. The apparatus according to claim 1, wherein the first criterion is when the number of persons per unit area in the real setting region is larger than a first congestion threshold.

11. The apparatus according to claim 2, wherein the second criterion is when the number of persons per unit area in the real setting region is smaller than a second congestion threshold.

12. The apparatus according to claim 1, wherein the device is a cash register, a ticket vending machine, a vending machine, an ATM or a gate.

13. A device selecting method comprising:
acquiring an image including a plurality of devices provided in a real world;
setting one device in operation, setting an image setting region corresponding to the one device on the image, and calculating an image congestion degree of persons existing in the image setting region;
calculating a real setting region on the real world corresponding to the image setting region from a positional relationship between the image and the real world, and calculating a real congestion degree in the real setting region from the image congestion degree; and
when the real congestion degree satisfies a predetermined first criterion, selecting a stopped device other than the set device in operation based on a predetermined first selection rule, and outputting operation information of the selected stopped device.

14. The method according to claim 13, further comprising:
when the real congestion degree satisfies a predetermined second criterion, selecting a device in operation other than the set device in operation based on a predetermined second selection rule, and outputting stop information of the selected device in operation.

15. The method according to claim 13, further comprising:
when a distance between congestion included in a image setting region having been set in past and newly added congestion is less than a distance threshold, connecting a range of the newly added congestion to the image setting region having been set in past and setting the connected congestion range as a new image setting region.

16. The method according to claim 13, wherein the image includes a state where the plurality of devices is arranged in a line, and
wherein the image setting region includes a region where a procession of persons exists.

17. The method according to claim 16, wherein the first rule is a rule of selecting a stopped device adjacent to the set device in operation.

18. The method according to claim 16, further comprising:
detecting, through image recognition, a fixture aligning or guiding the procession of persons in the image and setting the detected fixture in the image setting region.

19. The method according to claim 13, further comprising:
when the image congestion degree of the image setting region is higher than a predetermined first threshold, extending the image setting region by connecting a different region to the image setting region.

20. A non-transitory program stored in a computer readable medium, causing a computer to perform:
acquiring an image including a plurality of devices provided in a real world;
setting one device in operation, setting an image setting region corresponding to the one device on the image, and calculating an image congestion degree of persons existing in the image setting region;
calculating a real setting region on the real world corresponding to the image setting region from a positional relationship between the image and the real world, and calculating a real congestion degree in the real setting region from the image congestion degree; and
when the real congestion degree satisfies a predetermined first criterion, selecting a stopped device other than the set device in operation based on a predetermined first selection rule, and outputting operation information of the selected stopped device.
